(19) United States
(12) Patent Application Publication
(10) Pub. No.: US 2008/0087419 A1
(43) Pub. Date: Apr. 17, 2008

(54) Debris trapping, filtering, and tool protection apparatus

(76) Inventor: Robert Wood Fair, Tyler, TX (US)

Correspondence Address: Robert Wood Fair, 4828 S. Broadway #228, Tyler, TX, 75703, US

(21) Appl. No.: 11/904,702

(22) Filed: Sep. 28, 2007

Related U.S. Application Data
(60) Provisional application No. 60/848,071, filed on Sep. 29, 2006.

(51) Int. Cl. B01D 29/01

(52) U.S. Cl. 166/234; 210/225

(57) ABSTRACT

A trapping and filtering apparatus for removing solid contaminants from a fluid flowing in the interior of a pipe includes a filter media body, generally having an area for fluid contact substantially greater than the cross-sectional area of the pipe, disposed in the interior of the pipe to trap and retain contaminants without significantly impeding the flow of fluid through the pipe. The filter media may be formed in different configurations, and different means of connecting the filter media in the interior of the pipe may be employed.

### RELATED APPLICATION DATA

This application claims the benefits of U.S. Provisional Patent Application Ser. No. 60/848,071, filed Sep. 29, 2006.

### FIELD OF THE INVENTION

The present invention generally relates to debris traps and filters, and in its preferred embodiments more specifically relates to traps, filters, and other apparatus for removing debris from a fluid stream and protecting nozzle and orifice structures of a tool to be run through any type of potentially contaminated conduit.

### BACKGROUND

Some tools used in, especially but not limited to, well completion operations emit one or more, streams of working fluid from small nozzle orifices. Because of their small size, the nozzle orifices can be easily plugged by contaminants in the working fluid and/or contaminants in the conduit through which the tool is run. Such tools are often operated a substantial distance into a conduit, and the processes of positioning and retrieving the tool can be time consuming, and significant time and money can be lost if the tool must be retrieved and cleaned because of a nozzle blockage. Accordingly, it is desirable that the working fluid be free of contaminant particles large enough to plug a nozzle orifice before the working fluid reaches the tool for operation. Although the working fluid may be clean when started into a string of tubing to the tool, it can pick up contaminants during passage through the tubing string to the tool, and there is a need for effective cleaning and filtering of the working fluid in proximity to the tool itself.

### SUMMARY OF THE INVENTION

The present invention provides contaminant trap and filtering apparatus that addresses and meets that need. The present invention also provides a protective scraper and shield device for protecting tool nozzles and orifices during passage of the tool itself down a well casing, to prevent plugging of nozzle orifices from contaminants present in the casing outside the tool and the tubing providing working fluid to the tool. In the context of the invention, and for purposes of the following description, it is to be understood that the term “fluid” is used broadly, and encompasses any material capable of flow, specifically including but not limited to liquids and gasses. Further, in the context of the invention and the following description, the term “tool” is also used broadly, and encompasses and includes any nozzle, orifice, open ended delivery system, or a substantially closed pressurized system. The term “tool” also encompasses a fluid intake, and the scope of the invention is not limited by the direction of flow, whether to or from a tool. Similarly, the terms “tubing” and “pipe” are intended to be broadly encompassing and equivalent to each other, and are to be understood to include any type or nature of conduit, both rigid and flexible. The invention is useful in drilling operations, but its applicability is not limited to that field, and it is to be understood that the invention may be employed for a variety of other contexts, without limitation to any particular field. References to and discussion of functions such as trapping and filtering in the following description are not to be taken as limiting, and it is to be understood that the described apparatus may be used for any type of purification of fluids, for neutralization of constituents of a fluid stream, and/or in the context of bringing about chemical and/or physical changes in a fluid material.

In one set of embodiments the invention provides apparatus for filtering and/or trapping contaminants moving with or falling within a working fluid during its passage through a tubing string to a tool disposed down-hole in a well bore. The invention further provides a device to be disposed on the exterior surface of a tool, adjacent to and slightly below each nozzle, forming a barrier to intercept and divert contaminant materials away from the nozzle and fluid orifice.

The structure and selected features of several embodiments of the apparatus and device of the invention will be described in detail below with reference to the accompanying drawing figures.

### BRIEF DESCRIPTION OF THE DRAWINGS

FIG. 1 is a sectioned side elevation view of a trap apparatus 10 disposed in a section of tubing.

FIG. 2 is a top elevation view of a trap apparatus 10 disposed in a section of tubing.

FIG. 3 is a sectioned side elevation view of several units of trap apparatus 10 disposed in a section of tubing, illustrating one manner of use.

FIG. 4 is a sectioned side elevation view of a filter apparatus 20 disposed in a section of tubing.

FIG. 5 is a sectioned side elevation view of a filter apparatus 30 disposed in a section of tubing.

FIG. 6 is a partially cut-away top elevation view of a filter apparatus 30 disposed in a section of tubing.

FIG. 7 is a sectioned side elevation view of a filter apparatus 40 disposed in a section of tubing.

FIG. 8 is a bottom elevation view of a filter apparatus 40 disposed in a section of tubing.

FIG. 9 is a sectioned side elevation view of one embodiment of a filter apparatus 50 disposed in a section of tubing.

FIG. 10 is a sectioned side elevation view of another embodiment of a filter apparatus 50 disposed in a section of tubing.

FIG. 11 is a partially cut-away front elevation view of a device 60 in place below a nozzle and orifice of a tool.

FIG. 12 is a partially cut-away side elevation view of a device 60 secured in the surface of a tool below a nozzle and orifice.

FIG. 13 is a partially cut-away front elevation view of an alternative embodiment of a device 60 in place below a nozzle and orifice of a tool.

FIG. 14 is a partially cut-away side elevation view of the alternative embodiment of device 60 of FIG. 13, showing a securing structure.

FIG. 15 is a sectioned side elevation view of a trap apparatus with filter media extending fully across the interior of a section of tubing.

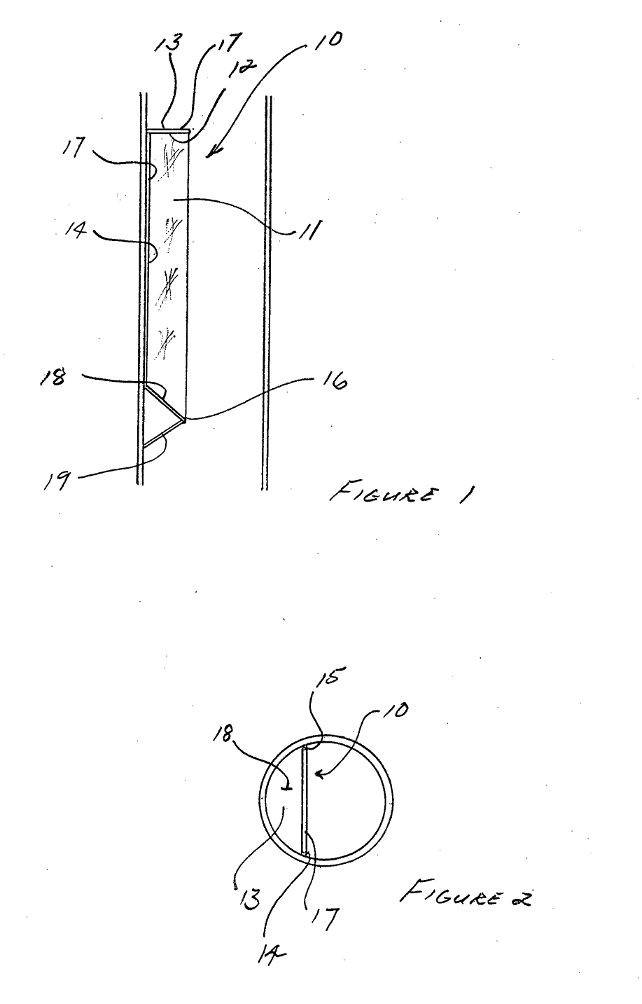

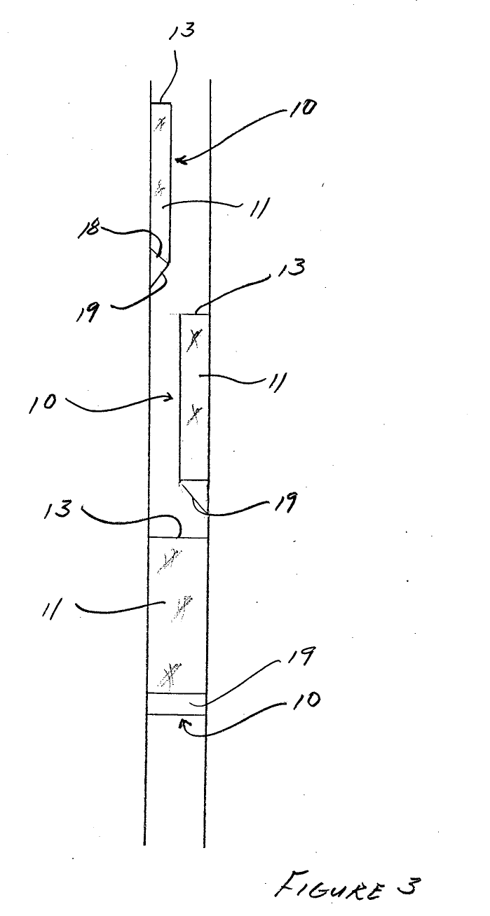

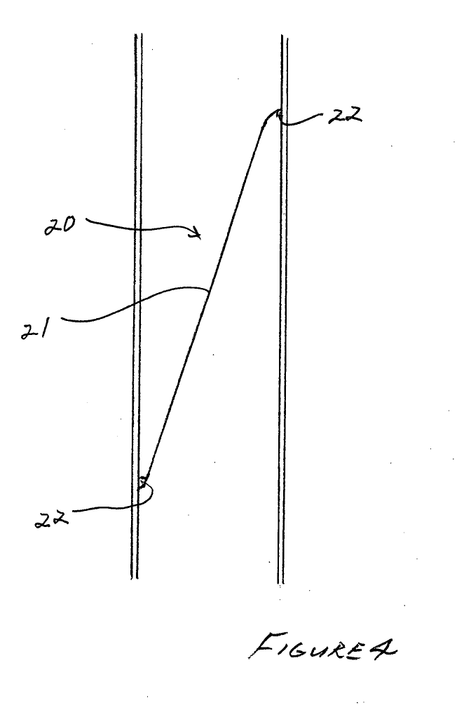

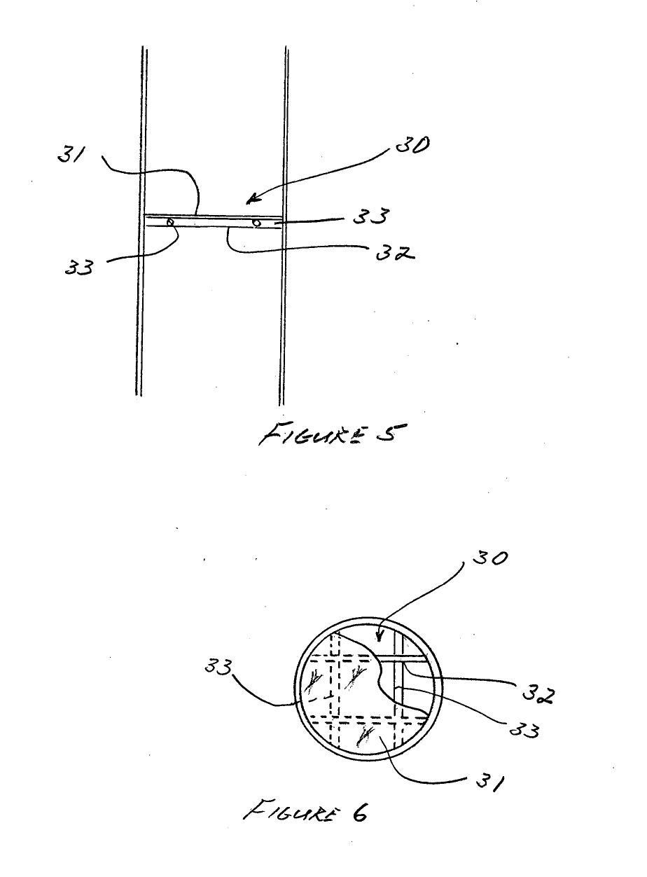

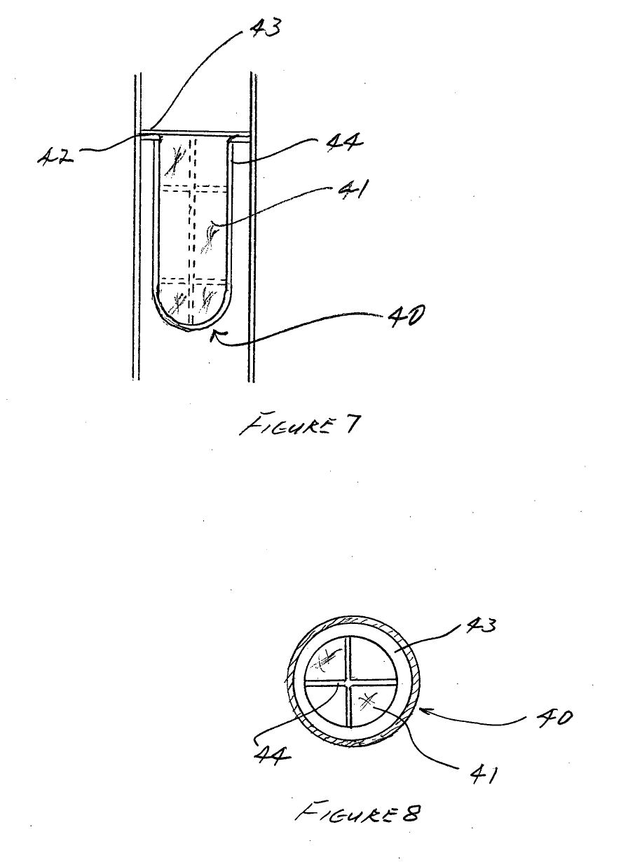

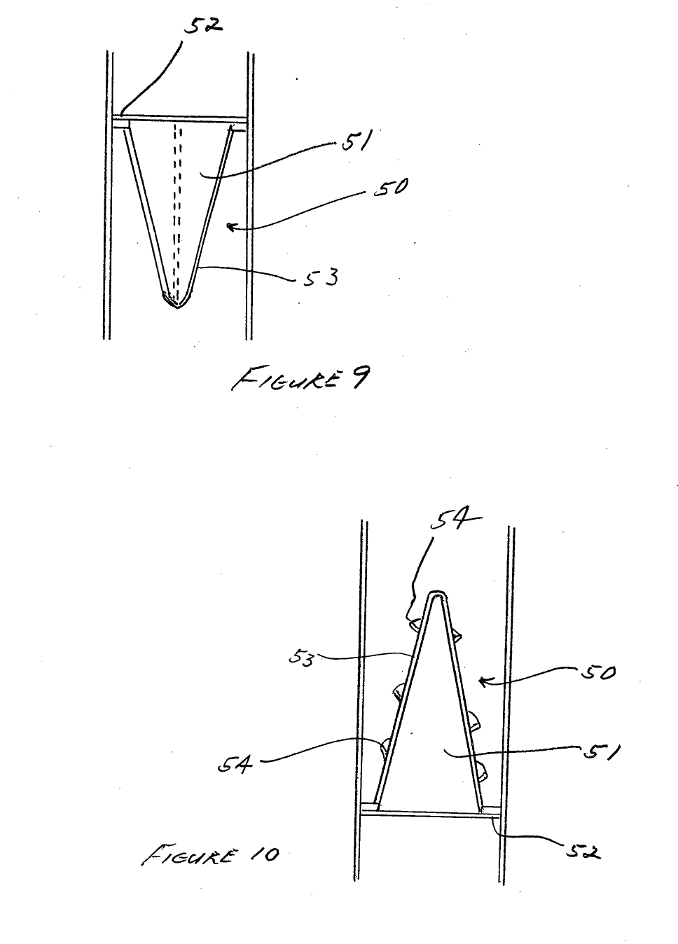

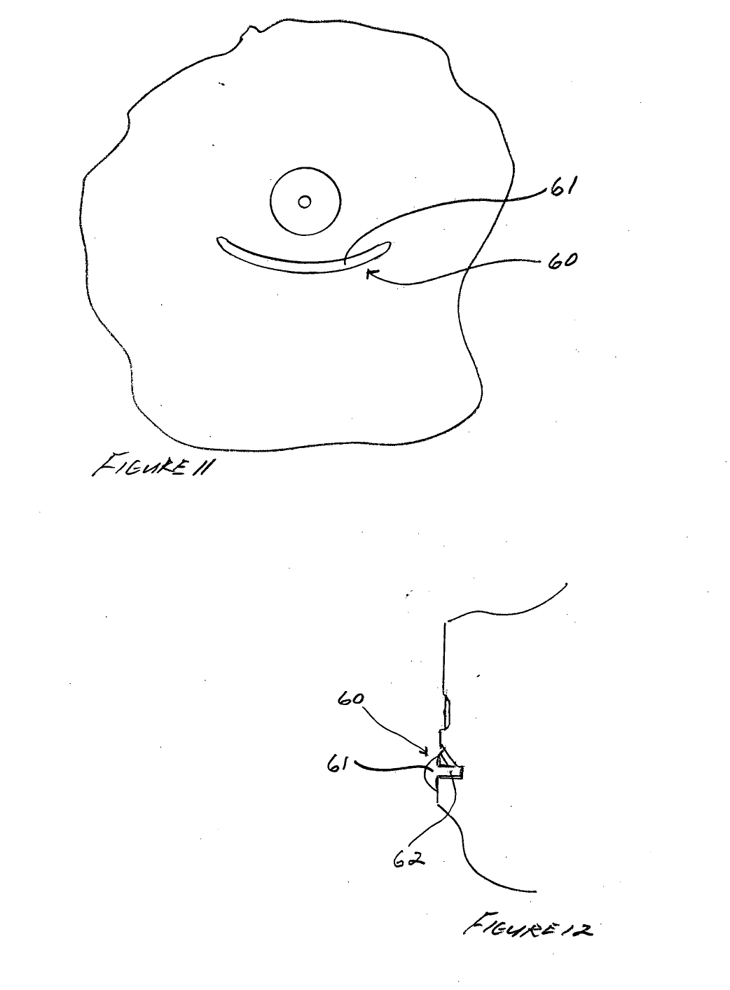

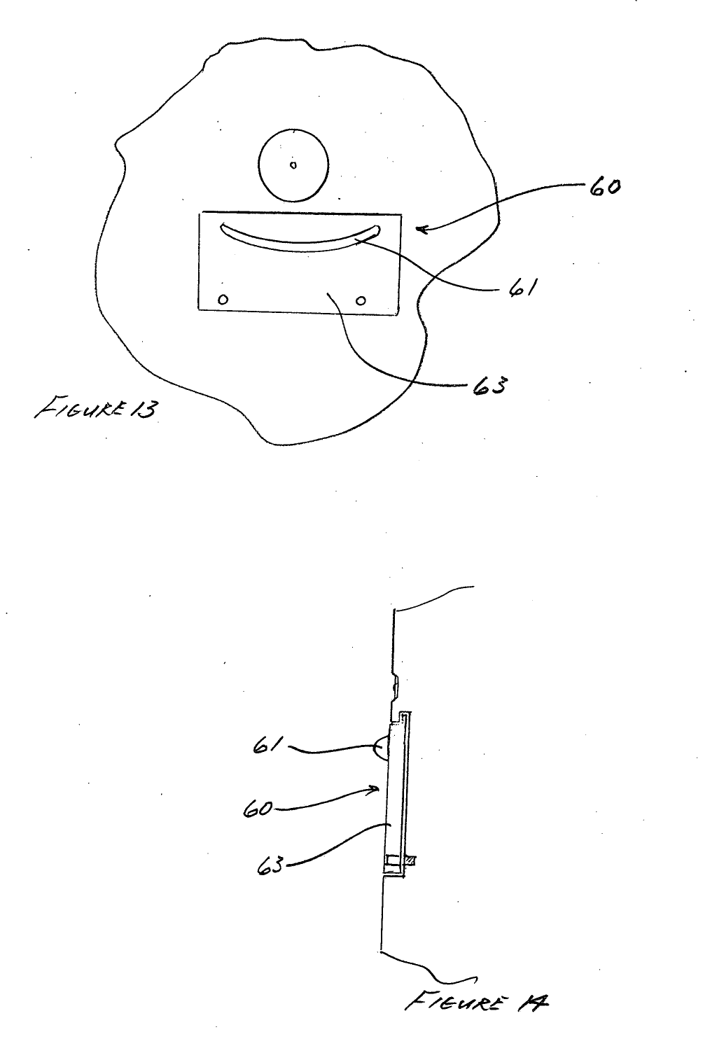

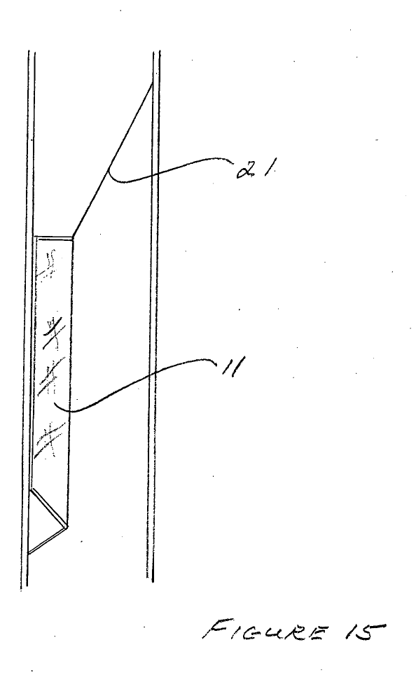

### DESCRIPTION OF THE INVENTION

Referring now to the drawing figures, the trap apparatus, generally designated by reference number 10, includes an elongate filtering media 11 that is disposed in the interior of a section of pipe or tubing through which working fluid is supplied to a down-hole tool. Filtering media 11 is preferably formed as a substantially planar body, preferably, but not required to be of greater length than width, and is disposed in the interior of a section of tubing with the plane of the body extending across the interior of the tubing with its upper, or first edge 12 lying along a chord line generally perpendicular to the longitudinal axis of the tubing, and with the plane of the filtering media generally parallel to the longitudinal axis of the tubing. It is preferred that the width of the upper edge of the filtering media, and the corresponding dimension of the chord line across the interior of the tubing, be less than the inside diameter of the tubing, so the filtering media divides the cross-sectional area of the tubing into two unequal portions. The smaller of those cross-sectional areas defines the upper end 13 of the trap apparatus 10, which remains open to the entry of working fluid and entrained contaminants into the trap.

The side edges, 14 and 15, of the filtering media extend along the inner wall of the tubing parallel to the longitudinal axis of the tubing from upper edge 12 to lower, or second edge 16. The filtering media is preferably retained in the interior of the tubing and supported by a supporting framework 17, which preferably includes at least a member extending along the upper edge of the filtering media and along the side edges of the filtering media. The filtering media is preferably connected to the framework structure, and the framework is itself connected to the inner surface of the tubing section in which the trap apparatus is disposed. The specific construction of supporting framework 17 is not critical to the scope of the invention, and a variety of structures and materials may be used, so long as the framework serves to support and retain the filtering media, and prevent deformation, or “blowout” of the filtering media in the event the working fluid pressure within the trap apparatus exceeds the pressure outside the trap.

The lower end of the trap apparatus is preferably closed by a diverter plate 18 connected to the interior of the tubing and to the lower edge 16 of the filtering media. Diverter plate 18 is disposed at a downward angle relative to the longitudinal axis of the tubing, so that fluid moving downwardly through the interior of the trap apparatus is diverted to flow outwardly through the filtering media adjacent to the diverter plate. It is also preferred that an anti-turbulence plate 19 be connected to the outer edge of the diverter plate and extend downward below the diverter plate back to the wall of the tubing, to which anti-turbulence plate 18 is also connected. The purpose of plate 19 is to maintain laminar flow of the working fluid down the tubing string, and especially in the area of the tubing in which the trap(s) of the invention are disposed, preventing fluid from “backing up” under the angled diverter plate and creating turbulence in the flow of working fluid down the tubing. Although the inclusion of plate 19 is preferred, it could be omitted if desired. The trap structure may be permanently connected within a section of tubing, or it may be removably connected within the scope of the invention.

In a variation, vortex creator devices may be added to the trap structure, and/or connected in the interior of the tubing in association with the trap apparatus structure, to create a diversion or a spiraling flow pattern for the fluid within the tubing. A diversion or spiraling flow can direct fluid to or from the pipe wall, and can force contaminant particles toward the tubing wall and help assure that contaminants flow into and are captured within the interior of a trap.

Filtering media 11 may take a variety of forms and configurations within the scope of the invention, including, but not limited to, a finely woven screen, a coarser mesh, and a plate penetrated by a plurality of apertures. The form and configuration of filtering media 11 may also vary within a unit of the trap apparatus. As a non-limiting example, course media may be used at one end of the trap, transitioning to finer media at the other end. The function of the filtering media is to allow working fluid and any desirable particles entrained therein to flow through the filtering media and down the tubing, while trapping contaminant particles behind the filtering media.

It is preferred that a plurality of traps 10 be disposed in the interior of the tubing, each preferably longitudinally offset along the pipe, and each also preferably radially offset from the trap apparatus above, to assure that the entire volume of the working fluid flowing down the tubing passes through at least one, and preferably several, traps. It is to be understood, however, that the scope of the invention encompasses placement of traps with no offset. The degree of radial offset, when used, is subject to variation within the scope of the invention, from zero degrees to a full 180 degree offset across the tubing. Among the objectives of the use of several traps in an offset orientation is to achieve the passage of up to the entire volume of the working fluid through the trap system, without passing the entirety of the fluid through any single trap. As a result, contaminants trapped by the filtering media are distributed through several traps rather than accumulating in a single trap and increasing the probability of blockage or blow-out of the filtering media.

In another embodiment of the invention, a single, substantially elongated filter or trap, generally designated by number 20, is utilized to remove contaminants from the working fluid passing down a string of tubing. In this embodiment an elongate, generally planar filtering media body 21 is connected along and across the interior of a section of tubing, disposed at a non-perpendicular angle relative to the longitudinal axis of the tubing. The magnitude of the angle at which the filtering media is disposed may vary within the scope of the invention. The filtering media fully covers the cross-sectional area of the tubing, but because of the elongation and angular disposition, the area of filtering media through which fluid passes as it travels down the tubing is substantially greater than the cross-sectional area of the tubing itself. As a result, the filtering media can retain a significant quantity of contaminant particles without impeding the flow of fluid through the filtering media. Further, because of the nearly vertical angle at which the filtering media is disposed (in a vertically oriented string of tubing), contaminants will tend to travel to the lower end of the trap created by the filtering media, leaving the upper area of the filtering media relatively open to fluid passage.

As with trap apparatus 10, trap 20 preferably includes a structural framework 22, to support the filtering media 21 and secure it to the interior of the section of tubing in which it is placed. As noted above, the framework and filtering media may be permanently connected within a section of tubing or may be removably connected. Further, the framework may be permanently connected and the filtering media removably connected to the framework. As noted above, the type of filtering media is subject to variation within the scope of the invention, including, without limitation, screen, mesh, or a plate with a plurality of apertures. As with the filtering media used in trap 10, the configuration and porosity of the filtering media used in trap 20 may vary within each unit of the apparatus.

In another embodiment, structured as a combination of trap 10 and filter 20, a section of filtering media 21 is extended upwardly and outwardly from the upper edge of filtering media 11 of trap apparatus 10, fully across the interior of the string of tubing in which the apparatus is disposed. With this embodiment, all working fluid flowing through the tubing passes through filtering media, and the placement of the filtering media encourages trapped debris to move into the trap area of the apparatus.

Another embodiment of the invention, generally designated by number 30, a generally planar disk of a filtering media 31 is disposed across the interior of a section of tubing, or more preferably, in a short connector collar, generally perpendicular to the longitudinal axis of the tubing or collar, supported upon and connected to a framework 32. Framework 32 preferably includes a plurality of rods 33, each connected to the interior of the tubing or collar along a chord line, and disposed generally perpendicular to the longitudinal axis of the tubing or collar. It is contemplated that filter 30 will be most effectively used below traps 10 or one or more traps 20, in which the majority of contaminants in the working fluid are removed and retained. Alternatively, a filter 30 may be effectively used when the contaminant concentration in the working fluid is low, and the limited surface area of filter media 31 will not retain a sufficient volume of contaminant particles to significantly impede the flow of working fluid. As with the previously described embodiments, the type of filter media used is not critical to the invention and is subject to variation.

In another embodiment, the filtering media surface area can be increased in a filter apparatus 40 by forming a filtering media body 41 as an elongate sock. The outer edge 42 of the sock is connected to an annular mounting ring assembly 43, which is, in turn, connected in the interior of a section of tubing or a connector collar. A variety of means for connecting a structure such as the mounting ring assembly within the interior of a section of tubing or a collar are known in the art, and any suitable means may be used within the scope of the invention. A supporting cage 44 preferably extends around the exterior of the sock from the mounting ring assembly, to support the sock and the weight of contaminant materials trapped therein and prevent the sock from separating from the mounting ring assembly and/or from blow-out resulting from fluid pressure against a filtering media body loaded with contaminants. Cage 44 may also extend in the interior of the sock, to prevent collapse of the sock structure. If desired, bypass apertures may be provided in the mounting ring assembly to allow the passage of fluid in the event that fluid passage through the sock is prevented by contaminant build-up. Bypass apertures, if used, may be fitted with closures, preferably secured to the mounting ring assembly to prevent them from falling down the tubing string when released, that will pop open in response to a selected working fluid pressure buildup. In a variation of this embodiment, the sock of filtering media may extend upwardly from the mounting ring assembly rather than hanging downwardly. In that variation, cage 44 is disposed in the interior of the sock rather than the exterior to provide appropriate support. Again, the type of filtering media used is not critical, and various types may be used within the scope of the invention. The porosity of the filtering media may also be varied within each unit.

In a related, but distinct embodiment, a filter apparatus 50 with a conical filtering media body 51 is used. As with the sock embodiment, body 51 may be disposed below a mounting ring assembly 52 or may extend upwardly from the mounting ring assembly with the apex of the cone disposed above the mounting ring assembly. Although the structural integrity of a conical body is greater than that of a sock-shaped body, and a cone is better able to resist deformation, a supporting cage or framework 53 may be used if desired, both outside and/or inside the cone. As with the embodiments described above, a variety of filter media types may be utilized within the scope of the invention, and the media porosity may vary within each unit of the apparatus.

Particularly with the variation of the conical filter embodiment in which the filter body 51 is disposed above the mounting ring assembly, vortex creator devices, such as vanes 54 may be mounted on body 51 or, more preferably, on a supporting framework 53. The vortex creator vanes or the like may extend beyond the apex of the conical body, upward in the tubing or connector collar. Vanes 54, or other vortex creator devices, create a spiraling flow pattern in the working fluid, tending to force contaminant particles outward toward the wall of the tubing or collar, out of the primary flow path through the filter body. With a spiraling flow pattern and resulting contaminant deposition around the perimeter of the filter body near the mounting ring, the filtering media itself does not become loaded with contaminants as quickly as would otherwise occur, and fluid flow through the filter media is less likely to be impeded.

As alluded to above, relating to the background of the invention, although the presence of contaminants in the working fluid flowing outwardly from the interior of a tool can block or clog nozzle orifices, those orifices can also be blocked by contaminant material outside the tool. Such blockages typically occur as the tool is lowered into a well bore or casing, often a the result of collisions between the tool and the well bore or well casing. Although less common, in some instances blockage occurring as a tool is withdrawn. In an effort to address this problem, nozzles may be recessed slightly from the outer surface of the tool, but this approach is often not effective.

The present invention provides a device to be disposed on the exterior surface of a tool, adjacent to and slightly separated from each nozzle, forming a barrier to intercept and divert contaminant materials away from the nozzle and fluid orifice, and to prevent the nozzle from scraping against the well bore or casing, which could plug or damage the nozzle. Typically, the barrier is disposed below the nozzle, but the invention also encompasses forming a barrier above the nozzle. In one embodiment the barrier device of the invention, generally designated by number 60, includes a rod 61, which is connected to the tool in the desired location. In the context of the invention and this description, the term “rod” is used broadly, and encompasses any form of protruding barrier, including but not limited to components commonly referred to as “rods”, “bars”, and variations thereof. The term also encompasses a protrusion formed on the tool itself. Further, although it is preferred that rod 61 be formed in a curved configuration, the configuration is not limited, and may encompass a straight configuration or a “V” configuration, as non-limiting examples.

In one embodiment rod 61 is formed with a thin flange 62 extending outwardly from the rod. Flange 62 is received in a slot formed in the exterior surface of the tool below and adjacent to a nozzle to be protected by the device, and preferably secured in the slot by one or more setscrews. Flange 62 and the slot in which flange 62 is received are preferably formed to create an interlock, such as a dovetail interlock, to positively retain the flange in the slot. Rod 61, in the preferred curved configuration, is disposed with its convex curvature extending outwardly from the nozzle on the surface of the tool. As the tool is moved a well bore or casing in the direction of concern, rod 61 will be the initial portion of the tool to encounter the wall of the casing or bore, and any loose contaminant material will tend to be scraped from the wall by the rod. The curvature of the rod diverts contaminant material outwardly from the nozzle and beyond the nozzle as the tool travels in the well bore or casing. As noted above, although rod 61 could be formed in a “V” configuration rather than a smoothly curved configuration, a “V” configuration is not preferred because the point of the “V” is more likely to dig into the well bore or casing and cause the tool to jam in the bore or casing.

In a variation of the structure for attaching rod 61 to the tool, rod 61 may be formed on a thin mounting plate 63, which may be disposed on the outer surface of the tool or seated in a shallow depression formed in the surface of the tool adjacent to the nozzle and secured with, e.g., setscrews. It is preferred that the depth of the depression not exceed the thickness of plate 63, to assure that rod 61 extends outwardly from the surface of the tool a sufficient distance to protect the nozzle. If desired, an undercut lip at the upper periphery of the depression may be formed, and a tab on plate 63 inserted under the lip to positively secure the position of the plate on the tool surface.

The foregoing description of the various embodiments of the invention and of certain variations therein is intended to be illustrative and not limiting. The invention is susceptible to other embodiments and variations within its scope, in accordance with the following claims.

1. A trap and filter apparatus disposed in the interior of a pipe, for removing solid contaminants from a fluid flowing through the interior of the pipe without interfering with the flow of fluid flowing through the interior of the pipe, comprising,
an elongate filter media formed as a thin substantially planar body of a material permeable to the fluid and impermeable to the solid contaminants to be removed from the fluid, said body having a first edge and a second edge in opposing and parallel relation to each other, each of said first and second edges having a first end and a second end, a first side edge and a second side disposed perpendicular to said first and second edges in opposing and parallel relation to each other, the lengths of said first and second edges being less than the inside diameter of the pipe, said filter media body disposed in the interior of the pipe with said first and second edges extending across the interior of the pipe generally perpendicular to the longitudinal axis of the pipe and connected to the pipe at their respective first and second ends, and with said side edges in contact with and extending along the pipe parallel to said longitudinal axis of the pipe, dividing the interior of the pipe along said filter media body into a smaller portion and a larger portion; and
a closure and diverter plate connected to said filter media body along said second edge thereof so as to close said smaller portion of the pipe at said second edge of said filter media body against the passage of both fluids solids through said closure and diverter plate.

2. The trap apparatus of claim 1, wherein said closure and diverter plate is disposed at a non-perpendicular angle relative to said longitudinal axis of the pipe such that fluid impacting against said closure and diverter plate is diverted from said plate toward said longitudinal axis of the pipe and along said pipe in the direction of the fluid flow.

3. The trap apparatus of claim 2, further comprising an anti-turbulence plate disposed at an opposite angle from said angle of disposition of said closure and diverter plate, and connected between said closure and diverter plate and the pipe.

4. The trap apparatus of claim 1, further comprising a structural frame extending along said first edge and said first and second side edges of said filter media body and connected to said filter media body, and wherein said filter media body is connected to the pipe by connecting said structural frame to the pipe.

5. The trap apparatus of claim 1, wherein said permeability of said filter media body varies between said first edge of said body and said second edge of said body.

6. The trap apparatus of claim 1, wherein said filter media body is a first filter media body, and wherein the trap apparatus further comprises a second filter media body disposed in the interior of the pipe and connected to the pipe, with said second filter media body offset radially and longitudinal in the interior of the pipe relative to said first filter media body.

7. The trap apparatus of claim 1, further comprising a plurality of additional said filter media bodies and said closure and diverter plates disposed and connected in the interior of the pipe, with each of said additional filter media bodies and said closure and diverter plates offset radially and longitudinally from immediately adjacent ones of said filter media bodies.

8. The trap apparatus of claim 1, further comprising a vortex creator means disposed in the interior of the pipe upstream of said first edge of said filter media in the flow of fluid through the pipe, for inducing solid contaminants in the fluid to move outwardly in the pipe relative to said longitudinal axis of the pipe before encountering said filter media body.

9. The trap apparatus of claim 7, further comprising a vortex creator means disposed in the interior of the pipe upstream of said filter media bodies in the flow of fluid through the pipe, for inducing solid contaminants in the fluid to move outwardly in the pipe relative to said longitudinal axis of the pipe before encountering said filter media bodies.

10. The trap apparatus of claim 1, further comprising an elongate filter plate formed of a material permeable to the fluid and impermeable to the solid contaminants to be removed from the fluid, said filter plate having a first end and a second end, with the length of said filter plate being greater than the inside diameter of the pipe, said filter plate connected in the interior of the pipe with said first end connected to said first edge of said filter media body such that said filter plate extends across and along a portion of the interior of the pipe at an angle relative to said longitudinal axis of the pipe with said filter plate disposed in the flow of fluid through the pipe upstream of said filter media body.

11. A trap and filter apparatus disposed in the interior of a pipe, for removing solid contaminants from a fluid flowing through the interior of the pipe without interfering with the flow of fluid flowing through the interior of the pipe, comprising an elongate filter plate formed of a material permeable to the fluid and impermeable to the solid contaminants to be removed from the fluid, said filter plate having a first end and a second end, with the length of said filter plate being greater than the longitudinal axis of the pipe, said filter plate connected in the interior of the pipe at a non-perpendicular angle relative to said longitudinal axis of the pipe, such that the area of said filter plate through which the fluid passes is greater than the cross-sectional area of the pipe.

12. The trap and filter apparatus of claim 11, wherein the permeability of said filter plate varies between said first end and said second end of said filter plate.

13. The trap and filter apparatus of claim 11, further comprising a structural framework extending around the perimeter of said filter plate and connected thereto.

14. A filter apparatus for removing solid contaminants from a fluid flowing through a pipe string formed of interconnected pipe sections, comprising,
a collar, formed as a short section of pipe, to be connected between two adjacent pipe sections in the pipe string, said collar having a hollow interior with an open first end and an open second end, and said collar having a longitudinal axis;
a support structure formed of a plurality of support members each extending across and connected to said collar within said interior of said collar in perpendicular relation to said longitudinal axis of said collar along a chord line other than a diameter line of said collar, with said support members lying in the same plane; and
a generally planar filter disk formed of a material permeable to the fluid and impermeable to the solid contaminants to be removed from the fluid, said disk having a diameter substantially equal to the inside diameter of said collar, said disk disposed in the interior of said collar upon said support structure.

15. A trap and filter apparatus to be disposed in the interior of a pipe for removing solid contaminants from a fluid flowing through the pipe, comprising,
an annular mounting ring connected in the interior of the pipe with said mounting ring lying in a plane generally perpendicular to the longitudinal axis of the pipe, said mounting ring defining a central aperture with a cross-sectional dimension less than the inside diameter of the pipe; and
an elongate filter body with a hollow interior, an open first end, and a closed second end, said filter body formed of a material permeable to the fluid flowing through the pipe and impermeable to the solid contaminants to be removed, said filter body connected at said open first end to said mounting ring around said central aperture, said body extending outwardly from said mounting ring along the interior of the pipe.

16. The trap and filter apparatus of claim 15, wherein said filter body extends from said mounting ring in a direction opposite the direction of flow of fluid through the pipe.

17. The trap and filter apparatus of claim 16, further comprising a support framework connected to said mounting ring and extending outwardly therefrom in said interior of said filter body so as to support and prevent collapse of said filter body in response to forces exerted by the flowing fluid and contaminants.

18. The trap and filter apparatus of claim 15, wherein said filter body extends from said mounting ring in the same direction as the flow of fluid through the pipe.

19. The trap and filter apparatus of claim 18, further comprising a support framework connected to said mounting ring and extending outwardly therefrom around the exterior of said filter body so as to support said filter body and assist in preventing failure of said filter body and disconnection of said filter body from said mounting ring in response to forces exerted by the flowing fluid and contaminants.

20. The trap and filter apparatus of claim 15, wherein said filter body is configured as a generally cylindrical sock.

21. The trap and filter apparatus of claim 15, wherein said filter body is configured as a cone, with said first end of said filter body being at the base of said cone and with said second end of said filter body being at the apex of said cone.

22. The trap and filter apparatus of claim 15, wherein said annular mounting ring is penetrated by a plurality of by-pass apertures for allowing fluid to pass through said by-pass apertures in the event of blockage of the flow of fluid through said filter body.

23. The trap and filter apparatus of claim 15, wherein said filter body extends from said mounting ring in a direction opposite the direction of flow of fluid through the pipe, further comprising vortex creator means disposed in the interior of the pipe for the purpose of creating a spiral flow of the fluid and inducing solid contaminants in said fluid to move outwardly in the interior of the pipe prior to contact of the contaminants with said filter body.

24. The trap and filter apparatus of claim 23, wherein said vortex creator means comprises a plurality of vanes connected in a spiral pattern around said filter body.

25. The trap and filter apparatus of claim 24, further comprising a support framework connected to said mounting ring and extending outwardly therefrom to support said filter body, and wherein said vanes of said vortex creator means are connected to said support framework.

26. A device to be connected to the exterior surface of a tool to be used in a well bore or casing, to prevent blockage of or damage from external contaminants to a nozzle provided on the tool for conveying fluid from the interior of the tool to the exterior of the tool, comprising a rod connected to the exterior surface of the tool such that said rod extends outwardly from the tool so as to precede the nozzle relative to the direction of movement of the tool iii the well bore or casing, and outwardly to either side of the nozzle, so as to direct contaminants encountered by said rod during movement of the tool in the well bore or casing away from the nozzle.

27. The device of claim 26, wherein said rod includes a flange extending along said rod and outwardly from said rod, and wherein said rod is connected to the tool by inserting and securing said flange in a groove formed in the exterior surface of the tool adjacent to the nozzle and slightly separated from the nozzle relative to the direction of movement of the tool in the well bore or casing.

28. The device of claim 27, wherein said flange and said groove are formed in an interlocking configuration such that said flange interlocks within said groove.

29. The device of claim 26, further comprising a mounting plate, wherein said rod is connected to said mounting plate, and wherein said rod is connected to the tool by connecting said mounting plate to the tool.

30. The device of claim 29, wherein said mounting plate is connected to the tool within a depression formed in the exterior surface of the tool.
